(19) United States
(12) Patent Application Publication
(10) Pub. No.: US 2026/0312459 A1
(43) Pub. Date: Oct. 8, 2026

(54) MOTOR

(71) Applicant: LG INNOTEK CO., LTD., Seoul (KR)

(72) Inventor: Moon Jae LEE, Seoul (KR)

(73) Assignee: LG INNOTEK CO., LTD., Seoul (KR)

(21) Appl. No.: 19/478,696

(22) PCT Filed: May 31, 2024
(86) PCT No.: PCT/KR2024/007475

§ 371 Date: Oct. 24, 2025

(30) Foreign Application Priority Data
Jun. 14, 2023 (KR) 10-2023-0076155

(51) Int. Cl. H02K 7/00; F16H 63/34; H02K 7/10

(52) U.S. Cl. CPC H02K 7/003; F16H 63/3433; F16H 63/3475; H02K 7/10

(57) ABSTRACT

The present invention may provide a motor which includes a shaft, a rotor coupled to the shaft, a stator disposed to correspond to the rotor, a housing which accommodates the stator and the rotor, a rotation part fixed to the shaft, an engagement part which is rotatably disposed on the housing and comes into contact with the rotation part to restrain rotation of the shaft, and a locking part which is disposed in the housing and restrains rotation of the engagement part.

### TECHNICAL FIELD

The present invention relates to a motor.

### BACKGROUND ART

An electronic braking system of a vehicle is a system which brakes a vehicle through operation of a motor and a speed reducer and has advantages of light weight, superior responsiveness, and less installation space restraint compared to a mechanical braking system. In addition, an electric parking brake of a vehicle is a device which automatically operates using an actuator according to an operation state of a vehicle even when a driver does not manually operate the vehicle.

Such an electric parking brake may be formed in a structure in which a shoe in a drum-in-hat (DIH) of a wheel extends due to tension generated by pulling a parking cable through rotation of a motor to secure a braking force or a spindle moves a piston forward through rotation of a motor to bring a disk and a pad into close contact with each other to secure a braking force.

Since the structure of the electric parking brake should be added to the electronic braking system in order to implement an electric parking brake function, there are problems that a large installation space is required, and a structure of related parts such as a speed reducer is complicated.

### DETAILED DESCRIPTION OF INVENTION

### Technical Problem

Therefore, the present invention is to solve the above-described problems and is directed to providing a motor in which a parking brake function is added to an electronic braking system to simplify a structure of an entire braking system.

Objectives to be achieved by the present invention are not limited to the above-described objectives, and other objectives that are not described above may be clearly understood by those skilled in the art through the following specification.

### Technical Solution

An embodiment may provide a motor which includes a shaft, a rotor coupled to the shaft, a stator disposed to correspond to the rotor, a housing which accommodates the stator and the rotor, a rotation part fixed to the shaft, an engagement part which is rotatably disposed on the housing and comes into contact with the rotation part to restrain rotation of the shaft, and a locking part which is disposed in the housing and restrains rotation of the engagement part.

The locking part may include a first locking part and a second locking part which are positioned to be spaced apart from the shaft in a radial direction and movably disposed in an axial direction, and the first locking part and the second locking part may sequentially come into contact with the engagement part to restrain the rotation of the engagement part.

A portion of the rotation part and a portion of the engagement part may selectively overlap in a circumferential direction.

A portion of the first locking part may be disposed to selectively overlap the engagement part in the circumferential direction, and a portion of the second locking part may be disposed to overlap the engagement part in the axial direction.

The first locking part may be disposed to overlap the engagement part in a circumferential direction to restrain the rotation of the engagement part.

A lower surface of the engagement part may be formed to be inclined.

The second locking part may push the lower surface of the engagement part to rotate the engagement part in a state in which the first locking part does not restrain the rotation of the engagement part.

The motor may further include a first elastic member which is disposed on the housing, is in contact with the engagement part, and provides an elastic force such that the engagement part rotates toward the rotation part.

The engagement part may include a first shaft part disposed on the housing, an arm part rotatably coupled to the first shaft part, and a tip portion which protrudes from the arm part and comes into contact with the rotation part, wherein the first elastic member may be in contact with the tip portion.

The first elastic member may be a torsion spring of which an axial center is parallel to an axial direction of the shaft.

An axial direction of the engagement part may be parallel to an axial direction of the shaft.

The first locking part may include a first cylinder, a first plunger disposed inside the first cylinder, and a first coil disposed inside the first cylinder, the second locking part may include a second cylinder, a second plunger disposed inside the second cylinder, and a second coil disposed inside the second cylinder, when a current is applied to each of the first coil and the second coil, the first plunger may move along the first cylinder and the second plunger may move along the second cylinder, the first plunger may be disposed to selectively overlap the engagement part in a circumferential direction, and the second plunger may selectively come into contact with a lower surface of the engagement part.

When the current is applied to each of the first coil and the second coil, a moving direction of the first plunger and a moving direction of the second plunger may be opposite to each other.

The first locking part may include a second elastic member disposed between the first cylinder and the first plunger, the second locking part may include a third elastic member disposed between the second cylinder and the second plunger, the second elastic member may be a coil spring having a restoring force when elongated, and the third elastic member may be a coil spring having a restoring force when contracted.

The housing may include a body disposed outside the stator and an extension portion extending from the body in a radial direction, and the extension portion may include a first accommodation portion in which a space for accommodating the first locking part is formed and a second accommodation portion in which a space for accommodating the second locking part is formed.

The housing may include a body disposed outside the stator and an extension portion extending from the body in a radial direction, and the extension portion may include a second shaft part to which the first elastic member is rotatably coupled and a stopper which comes into contact with the first elastic member.

### Advantageous Effects

According to one embodiment of the present invention, since a parking brake function is added to an electronic braking system, there is an advantage of simplifying a structure of an entire braking system.

According to one embodiment of the present invention, since a shaft of a motor of an electronic braking system is directly restrained so that a separate parking brake structure is not required, there are advantages of reducing an installation space and the number of parts.

According to one embodiment of the present invention, since a shaft is restrained though a locking part in a solenoid type, there is an advantage of more easily implementing a parking brake function.

### DESCRIPTION OF DRAWINGS

FIG. 1 is a view illustrating a motor according to an embodiment.

FIG. 2 is an exploded view illustrating the motor illustrated in FIG. 1.

FIG. 3 is a side view illustrating the motor illustrated in FIG. 1.

FIG. 4 is a view illustrating a rotation part.

FIG. 5 is a view illustrating an engagement part.

FIG. 6 is a cross-sectional view illustrating the engagement part along line A-A of FIG. 5.

FIG. 7 is a view illustrating the engagement part, a first locking part, and a second locking part.

FIG. 8 is an exploded view illustrating the first locking part and the second locking part.

FIG. 9 is a view illustrating a first plunger or second plunger.

FIG. 10 is a side cross-sectional view illustrating the first locking part.

FIG. 11 is a side cross-sectional view illustrating the second locking part.

FIG. 12 is a view illustrating a housing.

FIG. 13 is a view illustrating a state in which a shaft is unrestrained in a state in which a current is not applied to the first locking part and the second locking part.

FIG. 14 is a view illustrating positions of the first locking part and the second locking part corresponding to the engagement part in the state of FIG. 13.

FIG. 15 is a view illustrating a state in which the shaft is restrained by the engagement part when power is applied to the first locking part and the second locking part.

FIG. 16 is a view illustrating positions of the first locking part and the second locking part corresponding to the engagement part in the state of FIG. 15.

FIG. 17 is a view illustrating positions of the first locking part and the second locking part of which power is turned off in a state in which the engagement part restrains the rotation part.

FIG. 18 is a view illustrating a state in which restraint of the shaft is released as the engagement part escapes from the rotation part when power is applied to the first locking part and the second locking part in a state in which the shaft is restrained by the engagement part.

FIG. 19 is a view illustrating positions of the first locking part and the second locking part corresponding to the engagement part in the state of FIG. 18.

FIG. 20 is a view illustrating a state in which the first plunger of the first locking part moves the engagement part.

FIG. 21 is a view illustrating positions of the first locking part and the second locking part of which power is turned off in a state in which the engagement part has escaped from the rotation part.

### MODES OF THE INVENTION

Hereinafter, exemplary embodiments of the present invention will be described in detail with reference to the accompanying drawings.

However, the technical spirit of the present invention is not limited to the few embodiments which will be described and may be implemented in a variety of different forms, and one or more components of the embodiments may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, the terms used in the embodiments of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” may be used.

The terms are only to distinguish one component from another component, and the essence, order, and the like of the components are not limited by the terms.

In addition, it should be understood that, when a first component is referred to as being “connected,” “coupled,” or “linked” to a second component, such a description may include both a case in which the first component is directly connected, coupled, or linked to the second component, and a case in which the first component is connected, coupled, or linked to the second component with a third component disposed therebetween.

In addition, when a first component is described as being formed or disposed “on (above)” or “under (below)” a second component, such a description includes both a case in which the two components are formed or disposed in direct contact with each other and a case in which one or more other components are interposed between the two components. In addition, when a first component is described as being formed “on (above) or under (below)” a second component, such a description may include a case in which the first component is formed at an upper side or a lower side with respect to the second component.

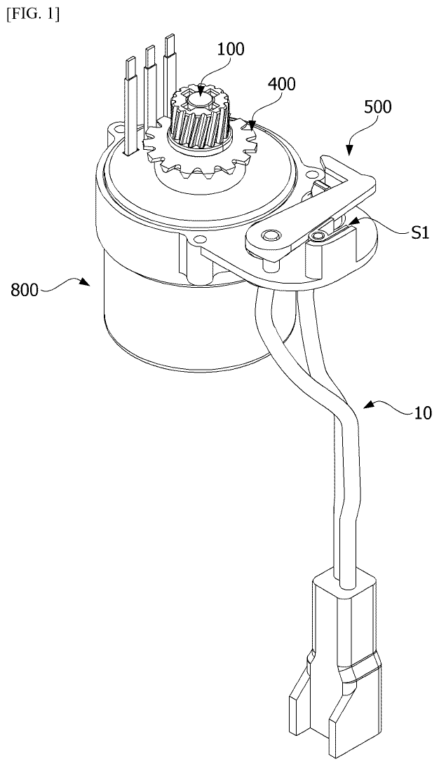

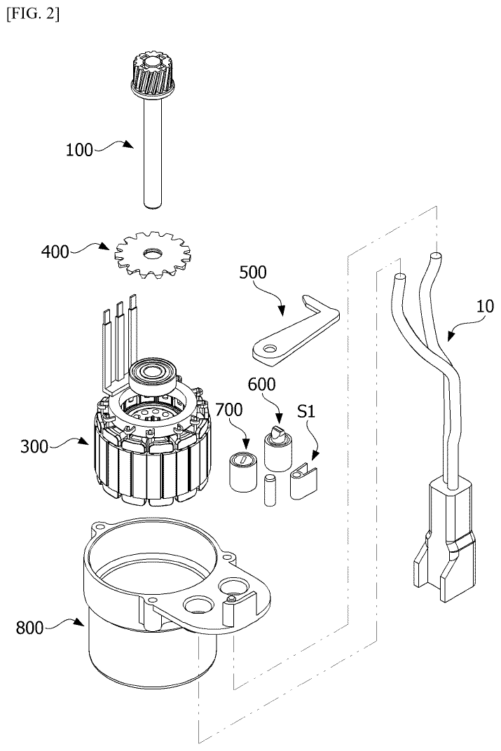

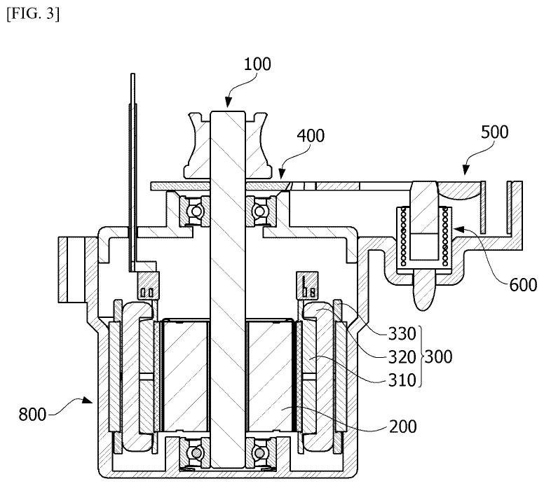

FIG. 1 is a view illustrating a motor according to an embodiment, FIG. 2 is an exploded view illustrating the motor illustrated in FIG. 1, and FIG. 3 is a side view illustrating the motor illustrated in FIG. 1.

Referring to FIGS. 1 to 3, the motor according to the embodiment may include a shaft 100, a rotor 200, a stator 300, a rotation part 400, an engagement part 500, a first locking part 600, a second locking part 700, and a housing 800.

Hereinafter, a circumferential direction and a radial direction are defined based on an axial center of the motor. An axial center of the rotation part 400 may be the same as the axial center of the motor. An axial center of the first locking part 600 may be parallel to the axial center of the motor.

Hereinafter, the motor has a feature of a parking brake function in addition to a brake function of a vehicle.

The shaft 100 may be coupled to the rotor 200.

The rotor 200 rotates through an electromagnetic interaction with the stator 300. The rotor 200 may be disposed to correspond to the stator 300. The rotor may be disposed inside the stator 300 in the radial direction. The rotor 200 may include a magnet.

The stator 300 may be disposed outside the rotor 200. The stator 300 may include a stator core 310, an insulator 320, and a coil 330. The insulator 320 is mounted on the stator core 310. The coil 330 may be wound around the insulator 320. The insulator 320 may be disposed between the coil 330 and the stator core 310 and may electrically insulate the stator core 310 from the coil 330.

The rotation part 400 may be coupled to the shaft 100. The rotation part 400 may be disposed outside the housing 800. As the shaft 100 rotates, the rotation part 400 may be integrally rotated with the shaft 100. The rotation part 400 is coupled to the first locking part 600 to serve to selectively restrain the shaft 100. The rotation part 400 may be disposed to overlap the rotor 200 in the axial direction.

The engagement part 500 may be rotatably coupled to the housing 800. An axial direction of the engagement part 500 may be parallel to an axial direction of the shaft 100. The engagement part 500 is engaged with the rotation part 400 to serve to restrain the shaft 100.

Locking parts may include the first locking part 600 and the second locking part 700.

The first locking part 600 may be coupled to the housing 800. The first locking part 600 is a part which implements a parking brake function by controlling rotation of the engagement part 500 to restrain the shaft 100 from rotating when the vehicle is stopped and a signal is applied thereto. Specifically, the first locking part 600 is disposed to selectively overlap the engagement part 500 in the circumferential direction to serve to restrain rotation of the engagement part 500.

The first locking part 600 may be coupled to a connector 10. The first locking part 600 may be disposed outside the housing 800. The first locking part 600 may be disposed not to overlap the rotor 200 or the stator 300 in an axial direction. In addition, the first locking part 600 may be disposed not to overlap the rotor 200 or the stator 300 even in the radial direction.

The second locking part 700 may be coupled to the housing 800. The second locking part 700 is another part which implements a parking brake function with the first locking part 600 by controlling rotation of the engagement part 500 to restrain the shaft 100 from rotating when the vehicle is stopped and a signal is applied thereto. Specifically, the second locking part 700 is disposed to selectively overlap the engagement part 500 in the axial direction to push a lower surface of the engagement part 500 and rotate the engagement part.

The second locking part 700 may also be connected to the connector 10. The second locking part 700 may be disposed not to overlap the rotor 200 or the stator 300 in the axial direction. In addition, the second locking part 700 may be disposed not to overlap the rotor 200 or the stator 300 even in the radial direction.

Both the first locking part 600 and the second locking part 700 may be located within a rotational radius of the engagement part 500. In addition, the first locking part 600 may be disposed farther away from an axial center of the engagement part 500 than the second locking part 700.

The housing 800 is disposed outside the stator 300.

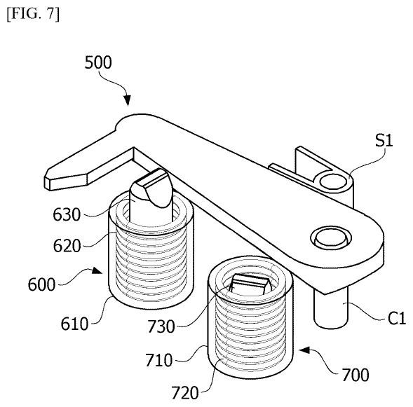

The engagement part 500 is moved by a first elastic member S1 (see FIG. 7). The first elastic member S1 is disposed in the housing 800 and provides an elastic force such that the engagement part 500 rotates toward the rotation part 400. The first elastic member S1 may be a torsion spring in contact with the engagement part 500.

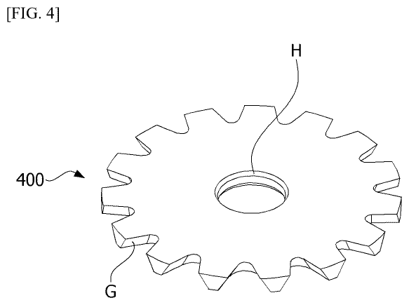

FIG. 4 is a view illustrating the rotation part 400.

Referring to FIG. 4, the rotation part 400 may be a disk member. The rotation part 400 may include a hole H through which the shaft 100 passes. The hole H may be disposed in a central portion of the rotation part 400. In addition, the rotation part 400 may include a plurality of groove portions G. The groove portions G may be disposed to be concave inward from an edge of the rotation part 400. The plurality of groove portions G may be disposed at predetermined intervals along the edge of the rotation part 400.

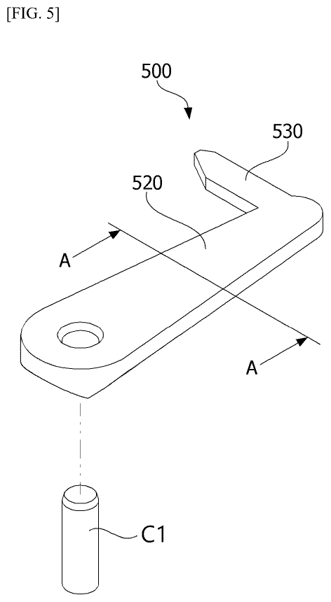

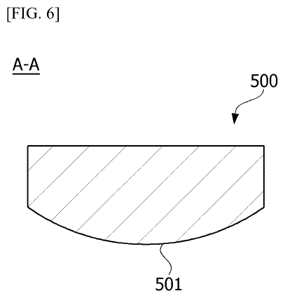

FIG. 5 is a view illustrating the engagement part 500, and FIG. 6 is a cross-sectional view illustrating the engagement part 500 along line A-A of FIG. 5.

Referring to FIGS. 4 to 6, the engagement part 500 may include a first shaft part C1, an arm part 520, and a tip portion 530. The first shaft part C1 may be coupled to the housing 800. An axial direction of the first shaft part C1 may be parallel to the axial direction of the shaft 100. One end of the arm part 520 may be rotatably coupled to the first shaft part C1. The arm part 520 may rotate about the first shaft part C1. The arm part 520 may have a shape in which a size of a cross section decreases toward the other end of the arm part 520. The tip portion 530 may extend from the other end of the arm part 520. The tip portion 530 may extend from the other end of the arm part 520 perpendicular to the arm part 5200. The tip portion 530 is inserted into one of the groove portion G of the rotation part 400. An end of the tip portion 530 may be sharply formed to be easily inserted into the groove portion G of the rotation part 400.

A lower surface 501 of the engagement part 500 may be a convexly curved surface. This configuration serves to induce rotation of the engagement part 500 when the second locking part 700 pushes the convex lower surface 501 of the engagement part 500.

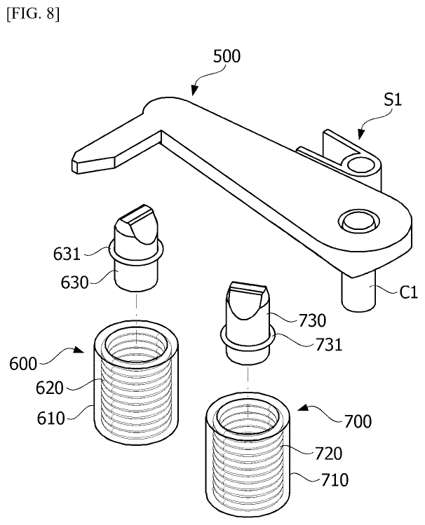

FIG. 7 is a view illustrating the engagement part 500, the first locking part 600, and the second locking part 700, and FIG. 8 is an exploded view illustrating the first locking part 600 and the second locking part 700.

The locking parts 600 and 700 may control rotation of the engagement part 500. The rotation of the engagement part 500 may be restrained, or the engagement part 500 may be rotated according to sequential driving of the locking parts 600 and 700.

Referring to FIGS. 7 and 8, the first locking part 600 and the second locking part 700 may be positioned below the engagement part 500 in the axial direction. In addition, the second locking part 700 may be disposed closer to the first shaft part C1 of the engagement part 500 than the first locking part 600. The first elastic member S1 is in contact with a side surface of the engagement part 500 to provide the elastic force normally such that the engagement part 500 is close to the rotation part 400.

The first locking part 600 may include a first cylinder 610, a first coil 620, and a first plunger 630.

The first cylinder 610 may be a cylindrical member in which a hollow is formed. The first plunger 630 may be disposed inside the first cylinder 610. The first coil 620 may be disposed in the first cylinder 610. The first plunger 630 is disposed in the hollow of the first cylinder 610 and straightly reciprocates. A contact region may be formed between the first cylinder 610 and the engagement part 500 to prevent the engagement part 500 from rotating when the first cylinder 610 moves in the axial direction.

The second locking part 700 may include a second cylinder 710, a second coil 720, and a second plunger 730.

The second cylinder 710 may be a cylindrical member in which a hollow is formed. The second plunger 730 may be disposed inside the second cylinder 710. The second coil 720 may be disposed in the second cylinder 710. The second plunger 730 is disposed in the hollow of the second cylinder 710 and straightly reciprocates. A contact region is formed between the second cylinder 710 and the lower surface 501 of the engagement part 500 to rotate the engagement part 500 when the second cylinder 710 moves in the axial direction.

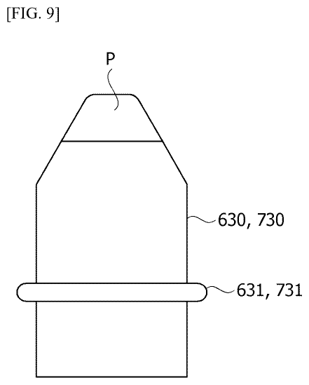

FIG. 9 is a view illustrating the first plunger 630 or the second plunger 730.

Referring to FIG. 9, shapes and sizes of the first plunger 630 and the second plunger 730 may be the same.

Each of the first plunger 630 and the second plunger 730 may include a protrusion P at a leading end thereof. Particularly, the protrusion P of the second plunger 730 may come into contact with the convex lower surface 501 of the engagement part 500 to induce rotation of the engagement part 500.

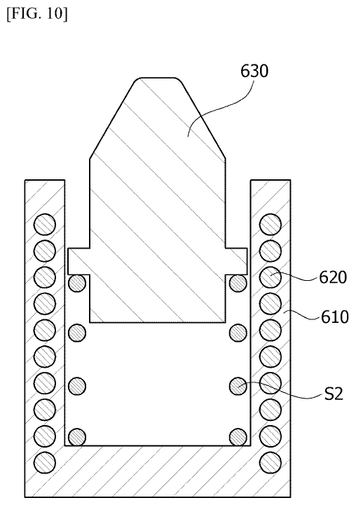

The first plunger 630 may include a first flange 631. The first flange 631 may protrude from an outer surface of the first plunger 630 and may be disposed along a circumferential portion of the first plunger 630. The first flange 631 serves to support a second elastic member S2 (see FIG. 10).

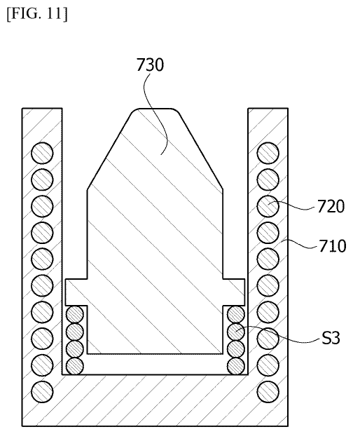

The second plunger 730 may include a second flange 731. The second flange 731 may protrude from an outer surface of the second plunger 730 and may be disposed along a circumferential portion of the second plunger 730. The second flange 731 serves to support a third elastic member S3 (see FIG. 11).

Each of the first plunger 630 and the second plunger 730 may be formed of a metal material.

FIG. 10 is a side cross-sectional view illustrating the first locking part 600.

Referring to FIG. 10, the first locking part 600 may include the second elastic member S2. The second elastic member S2 may be disposed between the first flange 631 and the first cylinder 610 in a moving direction of the first plunger 630. The second elastic member S2 may be a coil spring having a restoring force when contracted. In a state in which a current is not applied to the first coil 620, a state in which the first plunger 630 protrudes outward from the first cylinder 610 may be maintained by the second elastic member S2.

FIG. 11 is a side cross-sectional view illustrating the second locking part 700.

Referring to FIG. 11, the second locking part 700 may include the third elastic member S3. The third elastic member S3 may be disposed between the second flange 731 and the second cylinder 710 in a moving direction of the second plunger 730. The third elastic member S3 may be a coil spring having a restoring force when elongated. In a state in which a current is not applied to the second coil 720, the second plunger 730 may be positioned and maintained in the second cylinder 710 by the third elastic member S3.

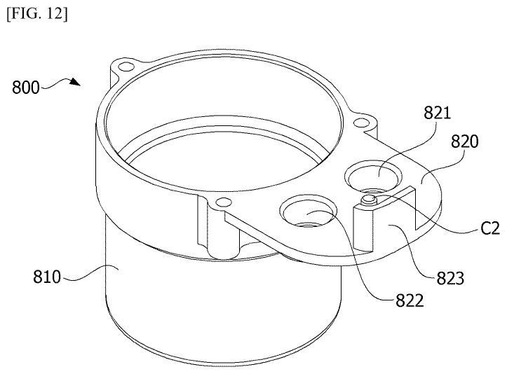

FIG. 12 is a view illustrating the housing 800.

Referring to FIG. 12, the housing 800 may include a body 810 and an extension portion 820. The body 810 is a cylindrical member inside which a space for accommodating the rotor 200 and the stator 300 is formed. The extension portion 820 may be formed to extend from an upper end of the body 810 in the radial direction.

The extension portion 820 may include a first accommodation portion 821 and a second accommodation portion 822. In the first accommodation portion 821, a space in which the first locking part 600 is accommodated may be formed. In addition, in the second accommodation portion 822, a space in which the second locking part 700 is accommodated may be formed. Since the first accommodation portion 821 and the second accommodation portion 822 are disposed in the extension portion 820 as described above, there is no need to provide a separate housing for accommodating the first locking part 600 and the second locking part 700.

In addition, the extension portion 820 may include a second shaft part C2. The second shaft part C2 protrudes from one surface of the extension portion 820. The second shaft part C2 is a part on which the first elastic member S1 is mounted. The first elastic member S1 may be disposed on the housing 800 and may provide the elastic force such that the engagement part 500 rotates toward the rotation part 400. The first elastic member S1 may rotate about the second shaft part C2.

The extension portion 820 may include a stopper 823. The stopper 823 may be in contact with the first elastic member S1 to support the first elastic member S1. The stopper 823 may protrude from one surface of the extension portion 820. The stopper 823 may be disposed close to the second shaft part C2. One end of the first elastic member S1 may be in contact with the stopper 823, and the other end of the first elastic member S1 may be in contact with the engagement part 500.

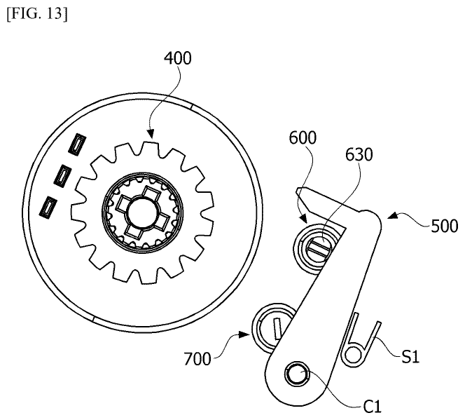

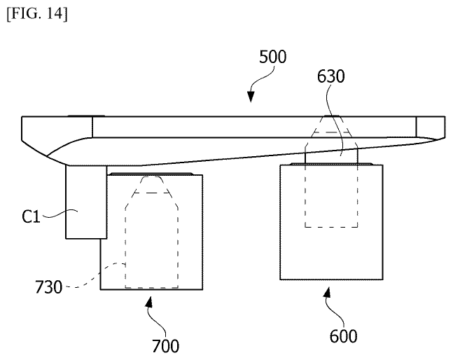

FIG. 13 is a view illustrating a state in which the shaft is unrestrained in a state in which a current is not applied to the first locking part 600 and the second locking part 700, and FIG. 14 is a view illustrating positions of the first locking part 600 and the second locking part 700 corresponding to the engagement part 500 in the state of FIG. 13.

When the vehicle is traveling or is stopped, in a case in which there is no additional signal, power is not applied to the first coil 620 and the second coil 720. As illustrated in FIGS. 13 and 14, in such a normal state, the first plunger 630 of the first locking part 600 protrudes due to the second elastic member S2 to be positioned to be hooked on one side surface of the engagement part 500. Although the engagement part 500 receives a force to be rotated because the first elastic member S1 is positioned on the other side surface of the engagement part 500, the first plunger 630 is in contact with one side surface of the engagement part 500 to prevent rotation of the engagement part 500.

In this case, since the second plunger 730 is positioned in the second cylinder 710 due to the third elastic member S3, the second plunger 730 is not in contact with engagement part 500.

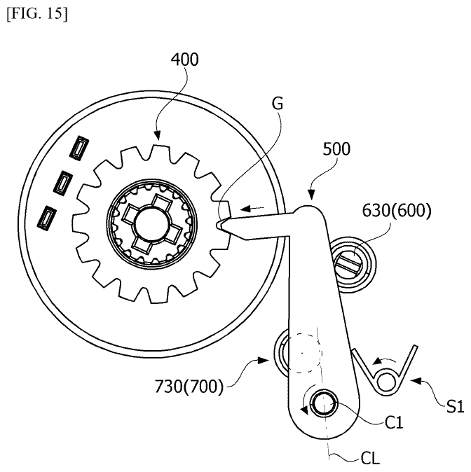

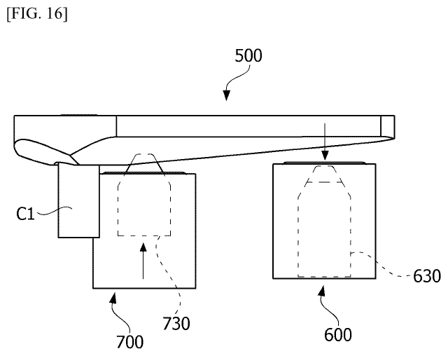

FIG. 15 is a view illustrating a state in which the shaft 100 is restrained by the engagement part 500 when power is applied to the first locking part 600 and the second locking part 700, and FIG. 16 is a view illustrating positions of the first locking part 600 and the second locking part 700 corresponding to the engagement part 500 in the state of FIG. 15.

The vehicle is in a parked state, a signal related to a parking brake is input, and power is applied to the first coil 620 and the second coil 720. The first plunger 630 is straightly moved along the first cylinder 610 by an electromagnetic interaction between the first coil 620 and the first plunger 630. The first plunger 630 overcomes the restoring force of the second elastic member S2 to enter the first cylinder 610. Since the first plunger 630 enters the first cylinder 610 and is released from contact with the engagement part 500, the engagement part 500 is rotated toward the rotation part 400 due to the first elastic member S1.

Meanwhile, the second plunger 730 is straightly moved along the second cylinder 710 with a time difference from the first plunger 630 by an electromagnetic interaction between the second coil 720 and the second plunger 730. The time difference in movement between the first plunger 630 and the second plunger 730 may be determined according to current control, differences in diameter, length, and elasticity coefficient between the first coil 620 and the second coil 720, differences in size and weight between the first plunger 630 and the second plunger 730, and the like. The second plunger 730 may overcome the restoring force of the third elastic member S3 to move until coming into contact with the lower surface 501 of the engagement part 500.

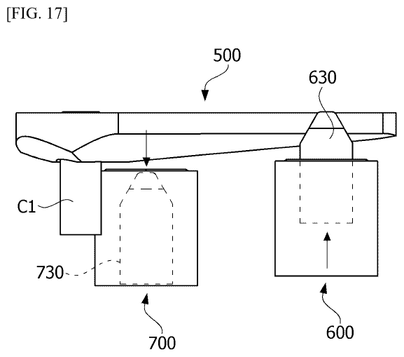

FIG. 17 is a view illustrating positions of the first locking part 600 and the second locking part 700 of which power is turned off in a state in which the engagement part 500 restrains the rotation part 400.

Referring to FIG. 17, in a state in which the engagement part 500 is hooked in the groove portion G of the rotation part 400 due to the first elastic member S1, when the power of the first locking part 600 and the second locking part 700 is turned off due to a state in which an engine of the vehicle is stopped or the like, the first plunger 630 protrudes outward from the first cylinder 610 due to the restoring force of the second elastic member S2 and is positioned to be hooked on the other side surface of the engagement part 500. In addition, the second plunger 730 enters the second cylinder 710 due to the restoring force of the third elastic member S3 to be spaced apart from the engagement part 500.

Since the first plunger 630 supports the other side surface of the engagement part 500 in addition to a restoring force of the first elastic member S1, the engagement part 500 does not rotate and remains engaged with the rotation part 400 to restrain the shaft 100 from rotating. That is, in a state in which the power of the first locking part 600 and the second locking part 700 is turned off, the shaft 100 may be restrained from rotating to implement a parking brake function.

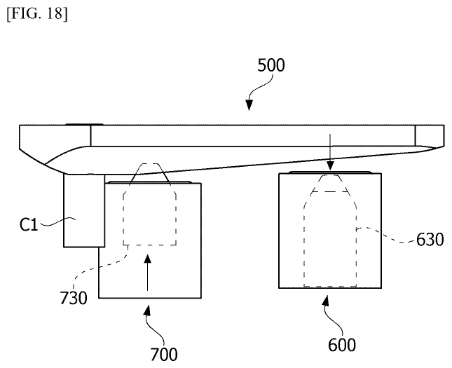

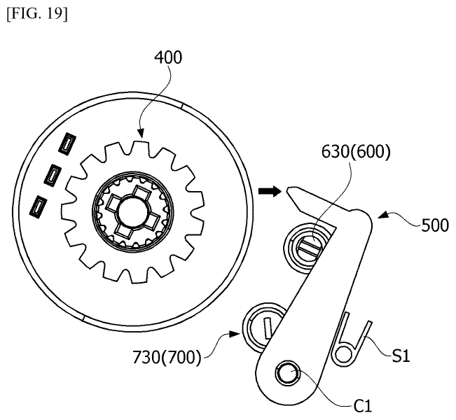

FIG. 18 is a view illustrating a state in which restraint of the shaft 100 is released as the engagement part 500 escapes from the rotation part 400 when the power is applied to the first locking part 600 and the second locking part 700 in a state in which the shaft 100 is restrained by the engagement part 500, and FIG. 19 is a view illustrating positions of the first locking part 600 and the second locking part 700 corresponding to the engagement part 500 in the state of FIG. 18.

When a signal is generated such as the engine of the vehicle being started or the like, in a state in which the engagement part 500 is engaged with the rotation part 400, a current is applied to each of the first locking part 600 and the second locking part 700. When the current is applied to each of the first locking part 600 and the second locking part 700, the first plunger 630 overcomes the restoring force of the second elastic member S2 to enter the first cylinder 610. Since the first plunger 630 enters the first cylinder 610, and contact between the first plunger 630 and the engagement part 500 is released, the engagement part 500 enters a state in which the engagement part 500 overcomes the restoring force of the first elastic member S1 to be rotatable.

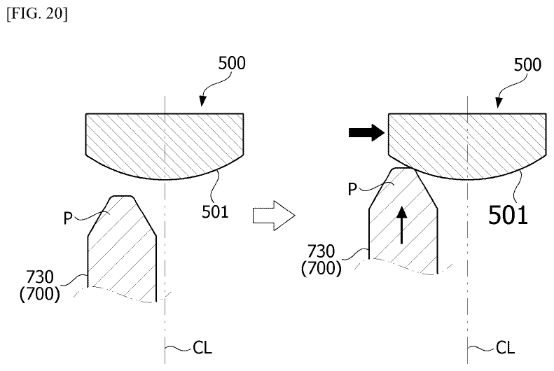

FIG. 20 is a view illustrating a state in which the first plunger 630 of the first locking part 600 moves the engagement part 500.

As illustrated in FIG. 20, the second plunger 730 overcomes the restoring force of the third elastic member S3 to move while pushing the lower surface 501 of the engagement part 500. In a state in which the engagement part 500 is engaged with the rotation part 400, the protrusion P of the second plunger 730 is positioned outside a width center of the engagement part 500 and positioned closer to the rotation part 400 than to a width center CL of the engagement part 500. Accordingly, when the protrusion P of the second plunger 730 pushes the lower surface 501 of the engagement part 500 upward, the engagement part 500 rotates away from the rotation part 400.

As described above, the second plunger 730 moves the engagement part 500 until the engagement part 500 reaches a position of the engagement part 500 in the normal state.

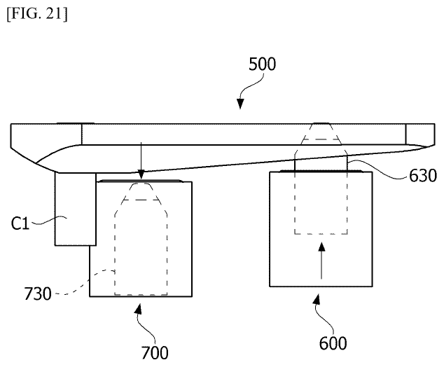

FIG. 21 is a view illustrating positions of the first locking part 600 and the second locking part 700 of which the power is turned off in a state in which the engagement part 500 has escaped from the rotation part 400.

Referring to FIG. 21, when the vehicle is traveling or is stopped, in a state in which there is no additional signal, in a case in which the power of the first locking part 600 and the second locking part 700 is turned off, the first plunger 630 of the first locking part 600 protrudes due to the second elastic member S2 and is positioned to be hooked on one side surface of the engagement part 500. Although the engagement part 500 receives a force to be rotated because the first elastic member S1 is positioned on the other side surface of the engagement part 500, the first plunger 630 on one side surface of the engagement part 500 blocks rotation of the engagement part 500. In this case, since the second plunger 730 is positioned in the second cylinder 710 due to the third elastic member S3, the engagement part 500 is not in contact with the second plunger 730.

Since the rotation part 400 connected to the shaft 100 of the motor of an electronic parking system is restrained, a separate parking brake structure is not required, and thus an installation space can be reduced, and the number of components can be reduced. In addition, since the shaft 100 is restrained through the locking part in a solenoid type, a parking brake function can be more easily implemented. Particularly, the parking brake function can be performed through two locking parts in a state in which the power for the locking parts is blocked.

The motor according to one exemplary embodiment of the present invention has been described above with reference to the accompanying drawings.

The above-described embodiments should be considered in a descriptive sense only and not for purposes of limitation, and the scope of the present invention is defined not by the detailed description but by the appended claims. In addition, it should be interpreted that the scope of the present invention encompasses all modifications and alterations derived from meanings and the scope and equivalents of the appended claims.

1.-16. (canceled)

17. A motor comprising:
a shaft;
a rotor coupled to the shaft;
a stator disposed to correspond to the rotor;
a housing which accommodates the stator and the rotor;
a rotation part fixed to the shaft;
an engagement part which is rotatably disposed on the housing and comes into contact with the rotation part to restrain rotation of the shaft; and
a locking part which is disposed in the housing and restrains rotation of the engagement part.

18. The motor of claim 17, wherein:
the locking part includes a first locking part and a second locking part which are positioned to be spaced apart from the shaft in a radial direction and movably disposed in an axial direction; and
the first locking part and the second locking part sequentially come into contact with the engagement part to restrain the rotation of the engagement part.

19. The motor of claim 18, wherein a portion of the rotation part and a portion of the engagement part selectively overlap in a circumferential direction.

20. The motor of claim 19, wherein:
a portion of the first locking part is disposed to selectively overlap the engagement part in the circumferential direction; and
a portion of the second locking part is disposed to overlap the engagement part in the axial direction.

21. The motor of claim 18, wherein the first locking part is disposed to overlap the engagement part in a circumferential direction to restrain the rotation of the engagement part.

22. The motor of claim 18, wherein a lower surface of the engagement part is formed to be inclined.

23. The motor of claim 22, wherein the second locking part pushes the lower surface of the engagement part to rotate the engagement part in a state in which the first locking part does not restrain the rotation of the engagement part.

24. The motor of claim 18, further comprising a first elastic member which is disposed on the housing, is in contact with the engagement part, and provides an elastic force such that the engagement part rotates toward the rotation part.

25. The motor of claim 24, wherein the engagement part includes:
a first shaft part disposed on the housing;
an arm part rotatably coupled to the first shaft part; and
a tip portion which protrudes from the arm part and comes into contact with the rotation part, and
wherein the first elastic member is in contact with the arm part.

26. The motor of claim 24, wherein the first elastic member includes a torsion spring of which an axial center is parallel to an axial direction of the shaft.

27. The motor of claim 17, wherein an axial direction of the engagement part is parallel to an axial direction of the shaft.

28. The motor of claim 18, wherein:
the first locking part includes a first cylinder, a first plunger disposed inside the first cylinder, and a first coil disposed inside the first cylinder;
the second locking part includes a second cylinder, a second plunger disposed inside the second cylinder, and a second coil disposed inside the second cylinder;
when a current is applied to each of the first coil and the second coil, the first plunger moves along the first cylinder, and the second plunger moves along the second cylinder;
the first plunger is disposed to selectively overlap the engagement part in a circumferential direction; and
the second plunger selectively comes into contact with a lower surface of the engagement part.

29. The motor of claim 28, wherein, when the current is applied to each of the first coil and the second coil, a moving direction of the first plunger and a moving direction of the second plunger are opposite to each other,

30. The motor of claim 28, wherein:
the first locking part includes a second elastic member disposed between the first cylinder and the first plunger;
the second locking part includes a third elastic member disposed between the second cylinder and the second plunger;
the second elastic member includes a coil spring having a restoring force when compressed; and
the third elastic member includes a coil spring having a restoring force when extended.

31. The motor of claim 18, wherein:
the housing includes a body disposed outside the stator and an extension portion extending from the body in a radial direction; and
the extension portion includes a first accommodation portion in which a space for accommodating the first locking part is formed and a second accommodation portion in which a space for accommodating the second locking part is formed.

32. The motor of claim 24, wherein:
the housing includes a body disposed outside the stator and an extension portion extending from the body in a radial direction; and
the extension portion includes a second shaft part to which the first elastic member is rotatably coupled and a stopper which comes into contact with the first elastic member.
